(19) United States
(12) Patent Application Publication
(10) Pub. No.: US 2009/0180070 A1
(43) Pub. Date: Jul. 16, 2009

(54) Velcro Creative Frames

(76) Inventor: Paula D. Poole, Chicago, IL (US)

Correspondence Address: MCDONNELL BOEHNEN HULBERT & BERGHOFF LLP, 300 S. WACKER DRIVE, 32ND FLOOR, CHICAGO, IL, 60606, US

(21) Appl. No.: 12/341,606

(22) Filed: Dec. 22, 2008

Related U.S. Application Data
(60) Provisional application No. 61/009,262, filed on Dec. 27, 2007.

(51) Int. Cl. G02C 11/02

(52) U.S. Cl. 351/52

(57) ABSTRACT

Eyeglass frames are provided that are made to have items or jewelry affixed to Velcro strips that are attached to the frames. These frames allow an individual to give the eyeglasses a different look every time that individual wears his or her eyeglasses. A male section of the strip is affixed to the eyeglass frames and comprises an exposed side with a dense layer of hooks and loops. A female section comprises decorative items on a first side and a dense layer of hooks and loops on a second side, which is opposed to the first side. The user may place the side of the female section with the hooks and loops against the exposed male section, affixing the female section to the male section.

This Application claims priority to U.S. Provisional Application No. 61/009,262, with a filing date of Dec. 27, 2007.

### FIELD

The present invention relates generally to eyeglass frames. More particularly, the present invention relates to Velcro strips for use with eyeglass frames.

### BACKGROUND

Soon after the first eyeglasses, frames to support the eyeglasses on the face of a user developed. Eyeglasses and frames for the eyeglasses have existed for at least several hundred years. The purpose of these frames has been to support the eyeglasses on a user's face. It has become increasingly popular for a user to express himself fashionably with his eyewear. Thus eyeglass frames come in a variety of styles, materials, and colors.

However, a user may wish to further individualize his eyewear. The current frames do not allow for much creative expression beyond color and material. Children who must wear glasses usually stand out among their peers. Glasses are typically seen amongst children as undesirable, as they are viewed as boring or perhaps even ugly. A child who has no choice but to embark upon wearing glasses may be upset by this new obligation, and dread wearing the boring, ugly glasses as he is trying to fit in with his peers. If the eyewear could be made to be fashionable and fun, a child might instead be excited to wear his glasses.

Adults may also wish to individualize their eyewear, and may become frustrated with the lack of options as they must select a frame that is available for purchase. Current frames on the market do not allow for a user to implement his own design changes to the frames.

### SUMMARY

An eyeglass frame and with Velcro strips for a user are provided. These frames and components allow the user to implement his own design changes by adding decorative items to the frame. The eyeglass frame comprises a first end piece and a second end piece. Each of the first end piece and the second end piece comprises a first end and a second end. The eyeglass frame also comprises a frame front, wherein the frame front comprises a bridge, a first rim, and a second rim. Each of the rims contains a lens. A first hinge attaches the first end of the first end piece to the first rim of the frame front. A second hinge attaches the first end of the second end piece to the second rim of the frame front. A male section is affixed to a surface on the eyeglass frame, wherein the male section comprises a side with a layer of Velcro. A female section comprises a decorative item side and a side with a layer of Velcro. The female section may be affixed to the male section when the Velcro side of the female section is pressed against the Velcro side of the male section.

In another embodiment, an attachment strip for use with an eyeglass frame is provided. A first side of a male section is affixed to a surface on the eyeglass frame. The male section also comprises a second side, wherein the second includes a layer of Velcro. A female section comprises a decorative item side and a Velcro side. The Velcro side of the female section is affixed to the Velcro side of the male section.

### BRIEF DESCRIPTION OF THE DRAWINGS

Various embodiments are described herein with reference to the following drawings. Certain aspects of the drawings are depicted in a simplified way for reason of clarity. Not all alternatives and options are shown in the drawings and, therefore, the invention is not limited in scope to the content of the drawings. In the drawings:

FIG. 1 illustrates a perspective view of an exemplary eyeglass frame according to the present invention;

FIG. 2a illustrates an exemplary hook and loop attachment according to the present invention;

FIG. 2b illustrates the hook and loop attachment of FIG. 2a; and

FIG. 3 illustrates the hook and loop attachment affixed to the eyeglass frames according to one embodiment of the present invention.

### DETAILED DESCRIPTION

In accordance with the present invention, eyeglass frames are provided. The eyeglass frames may be worn by men, women, and children of all ages. The eyeglass frames are made to have a Velcro attachment comprising items or jewelry affixed to the frames to give the frames a different look every time a user wears his eyeglasses. The eyeglasses used with the following invention may be made of a variety of materials, for example but not limited to wood, metal, bone, horn, or plastic. The eyeglass frames may be used for either correctional or non-correctional lenses.

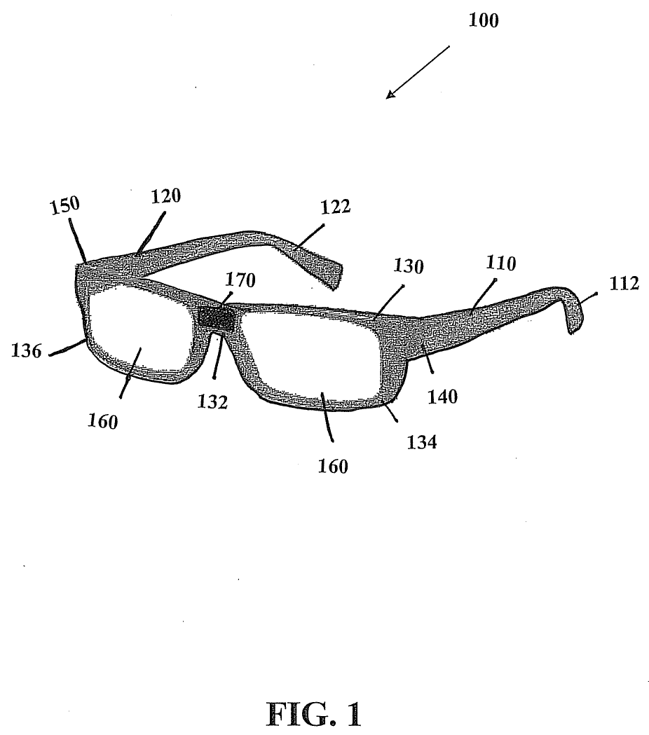

FIG. 1 shows a perspective view of an exemplary eyeglass frame 100 according to the present invention. Eyeglass frame 100 comprises a first end piece 110, a second end piece 120, a frame front 130, a first hinge 140, a second hinge 150, and a plurality of lenses 160. Frame front 130 further comprises a bridge 132, a first rim 134, and a second rim 136. First end piece 110 comprises a first temple 112. Second end piece 120 comprises a second temple 122.

First end piece 110 is connected to first rim 134 of frame front 130 with first hinge 140. Second end piece 120 is connected to second rim 136 of frame front 130 with second hinge 150.

At least one hook and loop attachment 170 may be attached to eyeglass frame 100. The attachment may be a Velcro attachment. Velcro refers generally to a hook and loop structure which when pressed together provides that two parts carrying the Velcro are releasably joined.

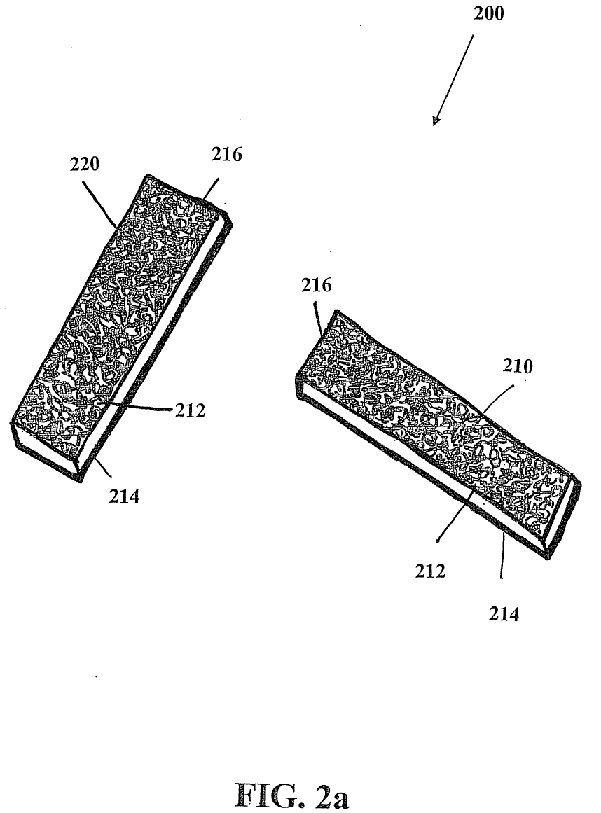

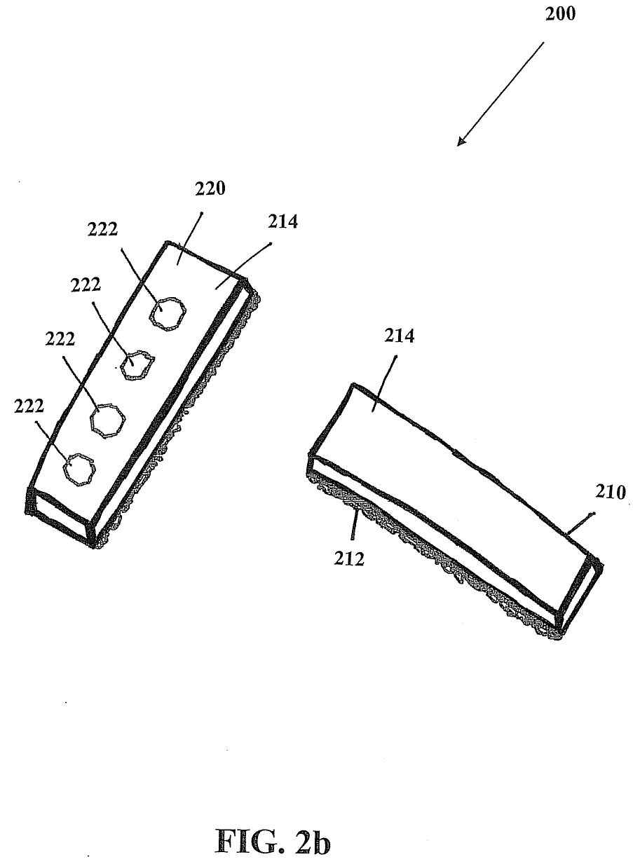

FIG. 2 illustrates an exemplary attachment 200 that may be affixed to eyeglass frame 100. The attachment 200 may comprise a hook and loop structure. The attachment comprises two parts; i.e., a male section 210 and a female section 220, as shown in FIG. 2a. The shapes and sizes of the male section 210 and female section 220 may comprise exact opposite positions with the same size, such that when female section 220 is mated with male section 210 the two sections comprise the same shape. Alternatively, female section 220 may not comprise the exact shape of male section 210. Female section 220 may comprise the same length as male section 210, but may be larger in width, for example. In another alternative, female section 220 may be slightly longer than male section 210 and may comprise rounded edges, wherein male section 210 may comprise straight edges. Various configurations of shape and size may be envisioned. The hook and loop structure may be Velcro, for example. Any of the varieties of Velcro currently in the art may be used for either the male section or the female section. Light to heavy-duty Velcro may be used. Additionally, the Velcro used on either the male section or the female section may comprise a variety of colors.

Each of male section 210 and female section 220 may comprise a first side 212 and a second side 214. First side 212 may be a side comprising a dense layer of hooks and loops 216. The material used for the hooks and loops may match the color of eyeglass frame 100. This way, if a user does not want to affix a female section 220 to a male section 210, the exposed hooks and loops from the first side 212 of the male section may blend with the frames, so that the attachment is barely noticeable. Hooks and loops 216 may be made from nylon. Alternatively, hooks and loops 216 may comprise a variety of other materials. Hooks and loops 216 may comprise a variety of thicknesses and lengths. In an alternative embodiment, hooks and loops 216 may not comprise loops or a hook or curled shape but instead may be straight in shape.

Second side 214 of male section 210 may comprise a layer of adhesive. A paper or other material may be pressed against the adhesive, preventing activation of the adhesive until removal of the material. FIG. 2b shows the second side of the attachment of FIG. 2a. Alternatively, male section 210 may be affixed to eyeglass frame 100 during the manufacturing process. In this case, an adhesive may still be used on first side 212 to affix the male section. However, other means of affixing male section 210 to the frames may be envisioned. For example, a specified surface of frames 100 may comprise an indented section, and male section 210 may be inserted into the indention section during the manufacturing process. An adhesive may still be used to ensure the male section 210 is secure within the indented section.

Second side 214 of female section 220 may comprise decorative items 222, as shown in FIG. 2b. Second side 214 is opposed to first side 212, as shown in the Figure. Decorative items 222 may be permanently affixed to second side 214. Second side 214 of female section 220 may comprise a different shape than first side 212 of female section 220. As an example, second side 214 may be in the shape of a butterfly, whereas first side 212 may be a circle shape or a square shape. Alternatively, second side 214 may comprise the same shape as first side 212.

Lighter weight frames may require lighter weight decorative items 222 affixed to second side 214 of female section 220. Heavier or thicker frames may be able to handle heavier decorative items 222 affixed to second side 214 of female section 220.

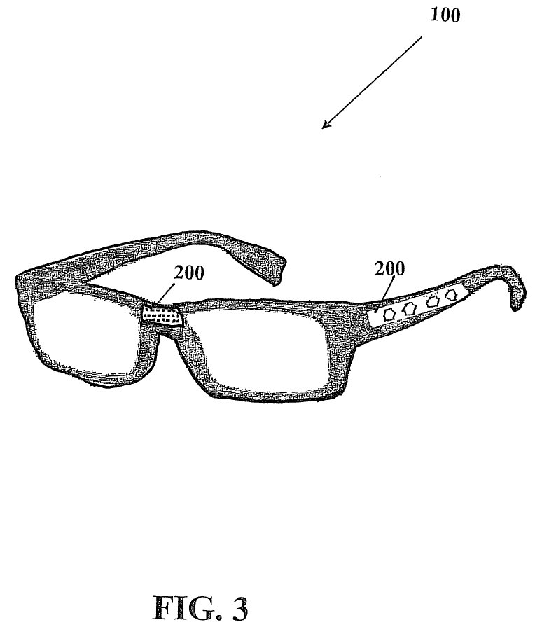

FIG. 3 illustrates attachment 200 affixed to eyeglass frames 100 according to one embodiment of the present invention. In operation, a user may wish to decorate his frames 100. The user may remove the paper or strip of material, exposing the adhesive layer on first side 212 of male section 210. Once the material is removed from the adhesive, a user may place male section 210 against a surface on eyeglass frames 100, pressing the adhesive against the surface. The adhesive will then bind male section 210 to the surface of eyeglass frames 100, affixing male section 210 to the frame.

The user may then select the female section 220 with the decorative items 222 the user desires to wear on the frame. It is preferable that the female section 220 chosen matches the size and shape of the male section 210 that has been affixed to the frames. The user takes the selected female section 220 and presses the first side 212 of the female section 220 against the first side 212 of male section 210. When the user presses the first sides together, the hooks from each side ensnare the hooks from the other side, effectively affixing the sides to each other. Exemplary affixed Velcro attachments are shown in FIG. 3 on eyeglass frames 100. As shown in FIG. 3, second side 214 of female section 220 may comprise a variety of decorative items 222 in different patterns.

Later, if the user wishes to remove the female section 220 from the frames, the user may manually pull female section 220 apart from male section 210. The hooks will give way under the manual pull, releasing themselves from the hooks previously ensnared. Female section 220 is then removed. The user may later affix a different female section 220 to eyeglass frames 100 by repeating the affixing procedure. Alternatively, the user may later affix the same female section 220 that was previously removed. The male and female sections of attachment 200 may be affixed and removed from each other many times.

It should be understood that the illustrated embodiments are examples only and should not be taken as limiting the scope of the present invention. The claims should not be read as limited to the described order or elements unless stated to that effect. Therefore, all embodiments that come within the scope and spirit of the following claims and equivalents thereto are claimed as the invention.

We claim:

1. An eyeglass frame, comprising:
a first end piece, comprising a first end and a second end;
a second end piece, comprising a first end and a second end;
a frame front, wherein the frame front comprises a bridge, a first rim, and a second rim;
a first hinge, wherein the first hinge attaches the first end of the first end piece to the first rim of the frame front;
a second hinge, wherein the second hinge attaches the first end of the second end piece to the second rim of the frame front;
a male section that is affixed to a surface on the eyeglass frame, wherein the male section comprises a side with a layer of hooks and loops; and
a female section, wherein the female section comprises a decorative item side and a side with a layer of hooks and loops, wherein the hooks and loops side of the female section is affixed to the side of the male section with the hooks and loops.

2. The eyeglass frame of claim 1, wherein the surface is a surface on the first end piece.

3. The eyeglass frame of claim 1, wherein the surface is a surface on the second end piece.

4. The eyeglass frame of claim 1, wherein the surface is a surface on the frame front.

5. The eyeglass frame of claim 1, wherein the Velcro side comprises a layer of hooks.

6. The eyeglass frame of claim 1, wherein the shape of the female section and the shape of the male section are such that when the female section is affixed to the male section the shape of the female section and the shape of the male section are the same.

7. The eyeglass frame of claim 5, wherein the length of the female section is the same as the length of the male section.

8. An attachment for use with an eyeglass frame, comprising:
a male section with a first side and a second side, wherein the first side is affixed to a surface on the eyeglass frame and the second side is opposed to the first side, wherein the second side comprises a dense layer of hooks and loops; and
a female section, wherein the female section comprises a decorative item side and an opposing side, wherein the opposing side comprises a dense layer of hooks and loops and wherein the opposing side of the female section is affixed to the second side of the male section.

9. The attachment of claim 8, wherein the surface is a surface on a first end piece of the eyeglass frame.

10. The attachment of claim 8, wherein the surface is a surface on a second end piece of the eyeglass frame.

11. The attachment of claim 8, wherein the surface is a surface on a front of the frame.

12. The attachment of claim 8, wherein at least one decorative item is affixed to the decorative item side.

13. The attachment of claim 8, wherein the hooks and loops are made from nylon.

14. The attachment of claim 8, wherein the opposing side of the female section is removably affixed to the second side of the male section.
